(19) United States
(12) Patent Application Publication
(10) Pub. No.: US 2006/0080655 A1
(43) Pub. Date: Apr. 13, 2006

(54) System and method for post-issuance code update employing embedded native code

(75) Inventor: Sylvain Prevost, Austin, TX (US)

Correspondence Address: Pehr Jansson, 9501 N. Capital of TX Hwy. #202, Austin, TX, 78759, US

(73) Assignee: Axalto Inc., Austin, TX (US)

(21) Appl. No.: 11/243,282

(22) Filed: Oct. 4, 2005

Related U.S. Application Data
(60) Provisional application No. 60/617,539, filed on Oct. 9, 2004.

(51) Int. Cl. G06F 9/44

(52) U.S. Cl. 717/173

(57) ABSTRACT

Updating system software of a resource-constrained device having a microprocessor. The system software is updated by embedding native code instructions in an application program that is downloaded onto the resource-constrained device. The native code instructions are selected from the instruction set requiring no processing prior to execution by the microprocessor. In response to detecting that an application contains embedded native code, passing the embedded native code directly to the microprocessor for execution.

### CROSS-REFERENCE TO RELATED APPLICATIONS

This invention claims priority pursuant to 35 U.S.C. 119 of U.S. Provisional Patent Application Ser. No. 60/617,539, filed on Oct. 9, 2004. This Provisional Application is hereby incorporated by reference in its entirety.

### BACKGROUND OF THE INVENTION

1. Field of the Invention

The present invention relates generally to updating system software loaded onto smart cards and more particularly to a mechanism for updating system code for smart cards with native code during the smart card life cycle.

2. Description of the Related Art

Smart cards are small personal computing devices that are used to protect very sensitive information. Smart cards may be used to perform banking functions, provide access to health records, personalization of computer network access, secure building access, and many more functions. Smart cards are also used as subscriber identity modules (SIM) in certain mobile telephony networks.

A crucial selling point of smart cards is the security of the data stored thereon or accessed through the use of smart cards.

A recent trend in smart card technology is so called multi-application smart cards. These cards may be programmed with multiple disjointed application programs. For example, the same card may be used to access both banking records as well as provide health care information. Examples of such cards include the Cyberflex family of cards from Axalto Inc.

The application programs are usually written in a high level language that is compiled off card and loaded onto the card in an in the form of a program written in a non-native instruction set (e.g., Java bytecodes, IL-opcodes). The system software on the card transforms the non-native code into instructions in a smart card chip native instruction set either through interpretation or just-in-time compilation for execution.

For security reasons, to prevent applications to access data or resources that are off-limits to application programs, many primitives that are available to card system software are not made available to application programs.

A common feature of multi-application smart cards is that the application programs may be loaded onto the smart card after the card has been issued by the manufacturer or even after an end-user has taken possession of the card. Each such application program in a multi-application smart card is stored in some form of programmable memory on the smart card. Such post-manufacture programmability of smart cards provides increased flexibility and power of use of the smart cards.

Thus, after a card has been issued, it is possible to update the functionality of the card by downloading new or updated application programs onto the card. However, the post-issuance update of the system software is very problematic because of the security risks involved in replacing system modules. Usually, updating of the system functions is de-activated when the card has been made ready for issuance.

This de-activation of system updates causes a number of problems. For one, it prevents new functionality to be added to a card that in theory is available in that portion of the native code that is made off-limits to application programs. Some functions that an operator may wish to add to a card may require access to the chip instruction set for performance reasons. Second, having the system fixed prevents the update of the system to correct bugs or other defects.

Furthermore, while it is possible to add functionality to the smart card post-issuance by loading new applications onto the card, because of the restrictions on what low level primitives such applications may utilize, it is not practical to use that mechanism for system updates.

In the prior art, in order to update the system, it was necessary to recall the smart card which needed the system update. With cards deployed in large quantities, recalling all cards in a deployment is impractical. Alternatively, entirely new cards may be manufactured for the purpose of replacing the cards that do not have the desired functionality. However, besides cost issues, that is undesirable because these new cards would not have all the applications that may have been loaded onto a smart card after issuance.

Accordingly, from the foregoing it is apparent that there is a hitherto unresolved need for a system and method for permitting the secure update of the system software for a smart card post-issuance while allowing access to native code instructions the use of which are not available to application programs.

### BRIEF DESCRIPTION OF THE DRAWINGS

FIG. 1 is a schematic illustration of the operating environment in which a smart card according to the invention may be used to provide secure computing services.

FIG. 2 is a schematic illustration of an exemplary architecture of a resource-constrained device.

FIG. 3 is a schematic illustration of a software architecture for a resource-constrained device.

FIG. 4 is a schematic illustration of a software architecture according to the invention in which one application program as illustrated in FIG. 3 in which system functionality is updated with application programs with embedded native code according to the invention.

FIG. 5 is a flow chart illustrating the operations of the loader of FIG. 4 according to the invention.

### DETAILED DESCRIPTION OF THE INVENTION

In the following detailed description and in the several figures of the drawings, like elements are identified with like reference numerals.

As shown in the drawings for purposes of illustration, the invention is embodied in a system and method for providing secure post-issuance updates to system functions. The invention accomplished the aforesaid advance in smart card technology by providing a mechanism in which application programs may have microprocessor native code embedded therein, which the on-card virtual machine can recognize as such and which the virtual machine passes directly to the central processing unit of the smart card for processing.

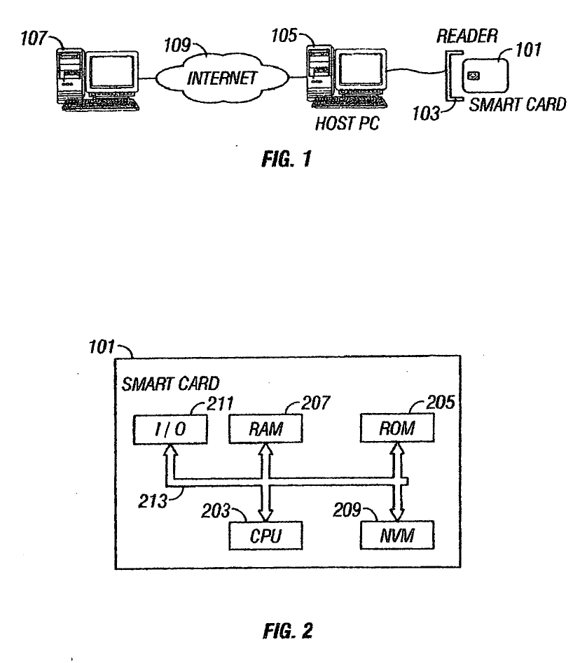

FIG. 1 is a schematic illustration of the operating environment in which a resource-constrained device according to the invention may be used to provide secure communication with a remote entity. A resource-constrained device 101, for example, a smart card, is connected to a computer network 109, for example, the Internet. The resource-constrained device 101 may be connected to the computer network 109 via a personal computer 105 that has attached thereto a card reader 103 for accepting a smart card. However, the resource-constrained device 101 may be connected in a myriad of other ways to the computer network 104, for example, via wireless communication networks, smart card hubs, or directly to the computer network 109. The remote node 105 is a computer system of some sort capable to implement some functionality that may either seek access to information on the smart card 101 or to which the smart card user may seek access. For example, the remote node 107 may be executing banking software that a user of the smart card 101 is seeking to obtain access to. The smart card 101 may then provide some access control functionality or may even be an electronic purse to which funds are downloaded from the remote computer.

The scenario of FIG. 1 is presented here merely for the purpose of providing an example and must not be taken to limit the scope of the invention whatsoever. Only the imagination of designers limits the myriad of possible deployment scenarios and uses for smart cards.

FIG. 2 is a schematic illustration of an exemplary architecture of a resource-constrained device 101. The resource-constrained device 101, e.g., a smart card has a central processing unit 203, a read-only memory (ROM) 205, a random access memory (RAM) 207, a non-volatile memory (NVM) 209, and a communications interface 211 for receiving input and placing output to a device, e.g., the card reader 102, to which the resource-constrained device 101 is connected. These various components are connected to one another, for example, by bus 213. In one embodiment of the invention, the SSL/TLS module 103, as well as other software modules shown in FIG. 1, would be stored on the resource-constrained device 101 in the ROM 206. During operation, the CPU 203 operates according to instructions in the various software modules stored in the ROM 205.

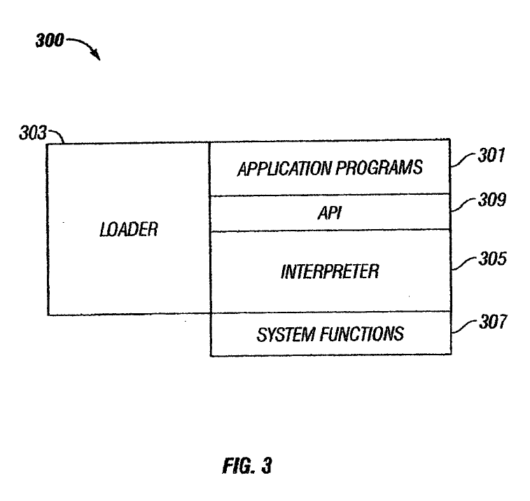

FIG. 3 is a block diagram of an exemplary software architecture 300 that one may find implemented on a smart card 101. The software architecture 300 includes several application programs 301. These are loaded onto the smart card by a loader 303. The application programs 301 would typically be loaded into the non-volatile memory 209. However, in other scenarios an application program may be permanently written onto the smart card at manufacture by having it stored in the ROM 205. If the smart card 101 were called upon to execute a program for only one session, it would be possible to have the program loaded in the RAM 207. However, that would be a rare circumstance. On the other hand, during execution of an application program, it is indeed possible that certain portions of the application program are loaded into the RAM 207.

In this example, a several application programs 301 are executed by the CPU 203 under the control of instructions of an interpreter 305. The interpreter 303 may, for example, be a Javacard Virtual Machine as found on the Cyberflex smart card family from Axalto Inc. of Austin, Tex. In alternative embodiments, the application programs 301 are compiled into executable code and do not require further interpretation by the interpreter 305. However, in such embodiments, the job control would be managed by some operating system program that would take the place of the interpreter 303.

The interpreter 303 is usually a static component of a smart card 101 and would therefore be loaded into the ROM 205. The interpreter 303 may also be burned into some form of firmware. In another alternative the interpreter 303 may be stored in the non-volatile memory 209.

In most embodiments of the invention, the smart card software architecture 300 also includes some system functions 307. System functions 307 may include security functionality, cryptography functionality, and utility libraries that may be called by application programs 301.

The application programs 301 may access functions provided by the smart card system software 307 by issuing calls through an application program interface 309.

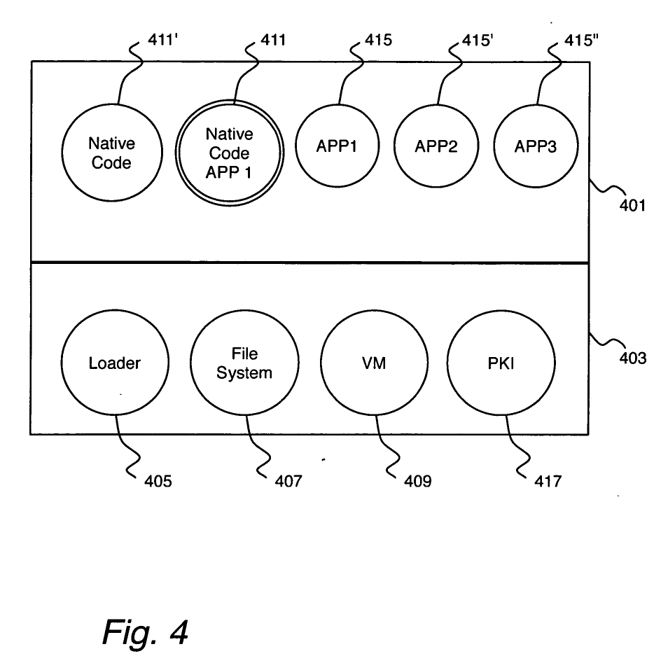

FIG. 4 is an alternative software architecture for a smart card in which native code bearing applications are employed to update system functionality according to the invention. In this architecture the software for the smart card are divided into application programs 401 and system functions 403. Generally, application programs may be loaded onto the smart card at any time during the life cycle, e.g., during issuance or even during the usage phase. The system functions 403 contain programs that control system functionality of the smart card. For example, the system functions include a loader 405 that operates to load new application programs onto the smart card, a file system 407 for managing data files stored on the smart card, and a virtual machine 409 for executing the application programs 403. Of course, the various application programs 401 and system programs 403 are interconnected, e.g., so that an application program 401 may call upon the file system 407 to access data and so on, however, those connections are not shown in the FIG. 4.

In a preferred embodiment of the invention, the system functions 403 may be updated with new functionality by downloading a native code bearing application program 411 that provides system functionality through embedded native code. Native code is such programming instructions that the central processor 203 can execute directly without further processing. That is in contrast to the non-native instructions with which application programs 401 are typically written. Usually, application programs 401 are written in high-level languages such as Java or C# and compiled into an intermediate language such as Java Card bytecodes or IL-opcodes off-card prior to loading. These intermediate language codes are then loaded onto the card and interpreted by a virtual machine 409.

The special native code bearing application programs 411 are downloaded onto the smart card 101 in the same manner as other application programs using the loader 405.

The loader 405 and the interpreter 409 according to the invention is capable of detecting and processing native code bearing application programs 411. In a preferred embodiment the interpreter 409 interprets a language in which methods may be assigned attributes. An example of such a language is C# and discussions of method attributes may be found in any C# text book and many on-line tutorials on C#. In the preferred embodiment a method with embedded native code is given the NativeCode attribute with a parameter value being a text string equivalent to the opcodes for the native code implemented by the function. The attribute NativeCode and its parameters form the body for the function that has the NativeCode attribute.

The native code bearing application program 411 contains a particular function header for any method with embedded native code that is indicative to the loader 405 and to virtual machine 409 that the method contains embedded native code. In the preferred embodiment, native code bearing application 411 methods with embedded native code bear the header 37 internal extern static”, which indicates to the virtual machine 409 that the method is a method with embedded native code. With respect to the loader 405, when it has detected that the native code bearing application 411 contains embedded code it finds in the load file the native code from the NativeCode attribute parameter. Similarly the virtual machine 409 detects from the method header that the method is a native code bearing method and that it should not attempt to interpret the body of the method but rather pass it onto the central processing unit 203 for execution in native mode. One way that the virtual machine 409 can pass control to the embedded code is to position the program counter of the central processor 203 at the memory location that the loader 405 placed the native code.

Consider for example a function that will increment the value i. Table 1 contains the assembly language for such a function:

TABLE 1
Assembly and Opcodes for Example Method

| | |
|---|---|
| Opcode | Instruction |
| | <NativeIncrement>: |

| | | |
|---|---|---|
| 39 12 | ldw | $r2 |
| 66 01 | mov | $r0,1 |
| 3C 12 | stw | $r2 |

| | | |
|---|---|---|
| C0 21 29 | add | $data0,$data2,$data1 |
| 78 | ret | |

(Note: this instruction set and opcodes correspond to the ST22L128 Smartcard 32-Bit RISC MCU from ST Microelectronics. However, the present invention is in no way limited to this particular processor and instruction set.)

Thus, the opcodes for the ST22L128 for that code section is “391266013C12C0212978”.

Table 1 is an example of an application program 411 with embedded native code:

TABLE 2
C# code for Application embedding
the opcode for the Example Method.

| | |
|---|---|
| 1 | public int NativeCallTest (int val) |
| 2 | { |

| | |
|---|---|
| 3 | return NativeIncrement (val) |

| | |
|---|---|
| 4 | } |
| 5 | [NativeCode (“391266013C12C0212978”)] |
| 6 | internal extern static int NativeIncrement (int |

i);

This example native code bearing application program 411 consists of two methods, namely, NativeCallTest and NativeIncrement. Whenever NativeCallTest is called, it calls NativeIncrement, which in turn is executed using the native code string provided. The virtual machine 409, when it encounters the call to NativeIncrement, redirects the program counter to that portion of memory at which the string “391266013C12C0212978” has been stored by the loader 405.

In a second aspect of the invention, the native code embedded into a native code bearing application program 411 is loaded into a specified address of the smart card system memory. Such an application is illustrated in Table 3.

TABLE 3
Embedded Native Code to be loaded at specific memory location.

| | |
|---|---|
| 1 | [NativeCode (0xA6100, “XX ... XX”)] |
| 2 | internal extern static void |

BiometricAlgorithmCorrection (void)

As illustrated, in this alternative mechanism for embedding native code in an application, the NativeCode attribute has two parameters, namely, an address at which to load the embedded native code and a character string representation of the opcodes to load at that address.

When the loader 405 encounters a native code bearing application 411 with a memory address parameter, the loader loads the corresponding native code string into the system memory beginning at that memory address. The native code bearing application 411 of Table 3 would be loaded at memory address 0xA6100. At run-time when the function BiometricAlgorithmCorrection () is called, the native code loaded at memory address is executed by the central processing unit 203.

In a preferred embodiment, an additional security mechanism is implemented. Any entity that seeks to update the system software 403 is required to be authorized for perfecting such system updates by downloading an application program with embedded native code 411. This check may be performed at two opportunities. First, by the loader 405 when the native code bearing application 411 is being loaded; second, by the virtual machine 409 at execution time. If the native code bearing application 411 has not been signed or has not been signed by an authorized entity, the application 411 is either rejected by the loader 405 or an error condition is flagged by the virtual machine 409 at run-time.

In a preferred embodiment, the authorization that the originating entity has the requisite rights to perform the download of an application 411 with embedded native code is performed using Public Key Infrastructure (PKI) digital certificates. Alternatively, the security mechanism is performed using the GlobalPlatform application signature mechanism (Delegate Loading) or dynamic authentication schemes.

The loader 405 and/or the virtual machine 409, upon detecting that an application program 411 has embedded therein native code, calls the PKI system 417 of the smart card 101 to verify that the application bears a digital signature from a trusted source. In a preferred embodiment, only the smart card manufacturer is deemed a trusted source. However, in alternative embodiments other trusted entities may be given the authority to access system level functionality by providing application program with embedded native code 411.

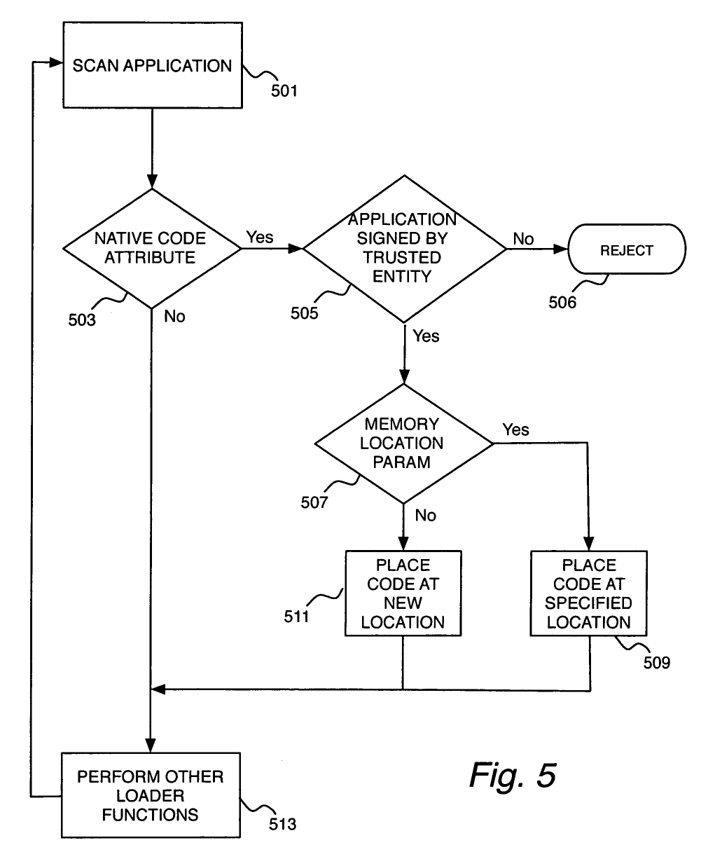

FIG. 5 is a flow chart illustrating the operations of the loader 405 according to the invention. The loader 405 operates to load the application program into the memory of the smart card and to resolve any unresolved references. While performing the loading operations, if the loader 405 encounters an application with a NativeCode attribute, step 503, the loader knows that it has detected a method with embedded native code and proceeds to process the application as such, steps 505 through 513.

A first step is to determine whether the entity that is attempting to download the application onto the smart card 101 may do so by determining whether the application has been signed by a trusted entity as described above, step 505. If the application 411 has not been signed by a trusted entity, the application 411 is rejected, step 506.

If the application may be loaded onto the smart card 101, the loader proceeds with determining whether the native code is to be placed at a particular memory location, step 507. If the NativeCode attribute indicates that the native code of the native code bearing application being loaded is to be placed at a particular location, it places the code at the specified memory location, step 509. If not, the loader 405 places the native code embedded in the application 411 into a new memory location, step 511.

Having concluded placing the native code bearing application 411 into memory of the smart card 101, the loader can proceed with other loader functions, step 513.

Although specific embodiments of the invention has been described and illustrated, the invention is not to be limited to the specific forms or arrangements of parts so described and illustrated. For example, the invention, while described in the context of smart cards for illustrative purposes, is applicable to other computing devices. The term system software is used throughout this document, however, smart card operating systems and other related modules may be embodied in ROM, non-volatile memory, firmware, programmable logic arrays, etc. In reading the specification and interpreting the claims, all such implementations are to be included in the term system software. Similarly, both in the specification and the claims, the term software taken in isolation should also be interpreted in a broad sense to include firmware, etc. The invention is limited only by the claims.

We claim:

1. A method of updating system software of a resource-constrained device having a microprocessor having associated therewith a native code instruction set requiring no processing prior to execution by the microprocessor, comprising:
providing functionality in the system software to determine whether an application contains embedded native code; and
in response to detecting that an application contains embedded native code, passing the embedded native code directly to the microprocessor for execution.

2. The method of claim 1, wherein the step of passing the embedded native code directly to the microprocessor comprises:
positioning the program counter at the embedded code.

3. The method of claim 1, wherein the step of determining whether an application contains embedded native code comprises detecting the presence of a header indicative of the presence of native code in the application.

4. The method of claim 1, wherein the step of passing the embedded native code directly to the microprocessor for execution comprises moving the microprocessor program counter to a location where the native code has been loaded into memory.

5. The method of claim 1, further comprising:
associating an originating entity with the application; and
determining whether the originating entity is authorized to update the system software by downloading an application with embedded native code.

6. The method of claim 5, wherein the originating entity is authorized if the originating entity is a trusted originating entity and the application containing embedded native code has been signed using a digital certificate.

7. The method of claim 1 wherein the system software has a loader for loading application programs and an application containing embedded native code has a memory address parameter and wherein the loader in response to detecting that an application program has a memory address parameter loads the embedded native code of the application containing embedded native code at an address specified by the address parameter.

8. A resource-constrained device having a processor having associated therewith a native code instruction set requiring no processing prior to execution by the microprocessor, comprising:
a memory connected to the central processing unit and containing application programs and system software for controlling operation of the microprocessor, the system software containing an operating system operable to execute the application programs loaded into the memory, the operating system containing logic to detect that an application program includes embedded native code and logic to pass such embedded native code directly to the microprocessor for execution.

9. The resource-constrained device of claim 8, wherein the logic to detect that an application program includes embedded native code comprises logic to detect that the application program contains a header indicative of that the application program contains embedded native code.

10. The resource-constrained device of claim 8, wherein the logic to pass such embedded native code directly to the microprocessor for execution comprises logic to place the microprocessor program counter at the location where the native code has been loaded into memory.

11. The resource-constrained device of claim 8, wherein an application program having embedded native code has an originating entity associated therewith, wherein the operating system further comprises logic to determine whether the originating entity is authorized to download application programs with embedded native code onto the resource-constrained device.

12. The resource-constrained device of claim 11, wherein the originating entity is authorized if the originating entity is a trusted originating entity and the application containing embedded native code has been signed using a digital certificate.

13. The resource-constrained device of claim 12 wherein the system software has a loader for loading application programs and an application containing embedded native code has a memory address parameter and wherein the loader in response to detecting that an application program has a memory address parameter loads the embedded native code of the application containing embedded native code at an address specified by the address parameter.
